SEQUENCE LISTING (4 sequences)

SEQ ID NO: 1 - DNA, 1770 bp, Ralstonia eutropha TB64
  CDS (1)...(1770) Polyhydroxybutyrate synthase encodingsequence
atggcgaccggcaaaggcgcggcagcttccacgcaggaaggcaagtcccaaccattcaagttcacgccggggccattcgatccagccacatggctggaatggtcccgccagtggcagggcactgaaggcaacggccacgctgccgcgtccggcattccgggcctggatgcgctggcaggcgtcaagatcgcgccggcgcagctgggtgatatccagcagcgctacatgaaggacttctcagcgctgtggcaggccatggccgagggcaaggccgaggccaccggtccgctgcacgaccggcgcttcgccggcgacgcatggcgcaccaacctcccatatcgcttcgctgccgcgttctacctgctcaatgcgcgcgccttgaccgagctggccgatgccgtcgaggccgatgccaagacccgccagcgcatccgcttcgcgatctcgcaatgggtcgatgcgatgtcgcccgccaacttccttgccaccaatcccgaggcgcagcgcctgctgatcgagtcgggcggcgaatcgctgcgtgccggcgtgcgcaacatgatggaagacctgacacgcggcaagatctcgcagaccgacgagagcgcgtttgaggtcggccgcaatgtcgcggtgaccgaaggcgccgtggtcttcgagaacgagtacttccagctgttgcagtacaagccgctgaccgacaaggtgcacgcgcgcccgctgctgatggtgccgccgtgcatcaacaagtactacatcctggacctgcagccggagagctcgctggtgcgccatgtggtggagcagggacatacggtgtttctggtgtcgtggcgcaatccggacgccagcatggccggcagcacctgggacgactacatcgagcacgcggccatccgcgccatcgaagtcgcgcgcgacatcagcggccaggacaagatcaacgtgctcggcttctgcgtgggcggcaccattgtctcgaccgcgctggcggtgctggccgcgcgcggcgagcacccggccgccagcgtcacgctgctgaccacgctgctggactttgccgacaccggcatcctcgacgtctttgtcgacgagggccatgtgcagttgcgcgaggccacgctgggcggcggcgccggcgcgccgtgcgcgctgctgcgcggccttgagctggccaataccttctcgttcctgcgcccgaacgacctggtgtggaactacgtggtcgacaactacctgaagggcaacacgccggtgccgttcgacctgctgttctggaacggcgacgccaccaacctgccggggccgtggtactgctggtatctgcgccacacgtacctgcagaacgagctcaaggtaccgggcaagctgaccgtgtgcggcgtgccggtggacctggccagcatcgacgtgccgacctatatctacggctcgcgcgaagaccatatcgtgccgtggaccgcggcctatgcctcgaccgcgctgctggcgaacaagctgcgcttcgtgctgggtgcgtcgggccatatcgccggtgtgatcaacccgccggccaagaacaagcgcagccactggactaacgatgcgctgccggagtcgccgcagcaatggctggccggcgccatcgagcatcacggcagctggtggccggactggaccgcatggctggccgggcaggccggcgcgaaacgcgccgcgcccgccaactatggcaatgcgcgctatcgcgcaatcgaacccgcgcctgggcgatacgtcaaagccaaggcatga

SEQ ID NO: 2 - DNA, 32 bp, Artificial Sequence
  Primer sequence for PCR
gagagaggatccaatcatggcgaccggcaaag

SEQ ID NO: 3 - DNA, 30 bp, Artificial Sequence
  Primer for PCR multiplication
cgggatccgcgaccggcaaaggcgcggcag

SEQ ID NO: 4 - DNA, 30 bp, Artificial Sequence
  Primer for PCR multiplication
cgatctcgagtcatgccttggctttgacgt

(19) United States
(12) Patent Application Publication
(10) Pub. No.: US 2003/0096115 A1
(43) Pub. Date: May 22, 2003

(54) Granular structure and process of production thereof

(76) Inventors: Shinya Kozaki, Tokyo (JP); Tetsuya Yano, Kanagawa (JP); Tsuyoshi Nomoto, Tokyo (JP); Tsutomu Honma, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/133,403

(22) Filed: Apr. 29, 2002

(30) Foreign Application Priority Data
Apr. 27, 2001 (JP) 2001-133535

(51) Int. Cl. B32B 5/16; B05D 7/00

(52) U.S. Cl. 428/404; 428/407; 427/212

(57) ABSTRACT

A capsular structure is provided which does not cause load to the environment and the living things, produced by utilizing PHA having various functionality, enclosing cores at a high density without limitation of the core material. The granular structure has granules coated at least partly with a polyhydroxyalkanoate constituted of monomer units of at least one of 3-hydroxypropionic acid, 3-hydorxy-n-butyric acid, and 3-hydroxy-n-valeric acid.

### BACKGROUND OF THE INVENTION

1. Field of the Invention

The present invention relates to a granular structure which has an outer shell for enclosing a granular material (hereinafter the enclosed matter being referred to as a “core”), the outer shell being formed from a homopolymer or copolymer composed of monomer units selected from 3-hydroxypropionic acid, 3-hydroxy-n-butyric acid, and 3-hydroxy-n-valeric acid (hereinafter the granular structure being referred to as a “capsular structure”). This granular structure is useful in broad application fields such as paints, inks, coatings, adhesives, fire extinguishants, cosmetics, building materials, pesticides, medicines, diagnostic agents, and fertilizers. The present invention also relates to a process for producing the aforementioned granular structure using neither a surfactant nor an organic solvent. The present invention further relates to use of this granular structure for an electrophotographic toner.

2. Related Background Art

Microcapsules are being studied for various uses such as paints, inks, coatings, adhesives, fire extinguishants, cosmetics, building materials, pesticides, medicines, diagnostic agents, and fertilizers. For example, Japanese Patent Application Laid-Open No. 5-085873 discloses a controlled-release fertilizer. Japanese Patent Application Laid-Open No. 6-295059 discloses a heat-sensitive recording material. Japanese Patent Application Laid-Open No. 9-208494 discloses a microcapsule preparation of a controlled-release medicine.

Japanese Patent Application Laid-Open No. 8-286416 discloses a capsular toner having chargeability stabilized. Japanese Patent Application Laid-Open No. 9-292735 discloses a heat-sensitive capsular toner. Further, Japanese Patent Application Laid-Open Nos. 5-119531, 5-249725, 6-332225, 9-43896, 10-78676, 11-7163, 2000-66444, 2000-112174, 2000-330321, and so forth disclose capsular toners.

In recent years for energy saving, the toner for electrophotography is required to be fixable at a lower temperature. For the low-temperature fixation of the toner, lowering of the glass transition temperature of the binder resin constituting the toner is effective directly, and has been investigated widely. However, excessive lowering of the glass transition temperature of the toner can cause blocking of the toner particles, poor chargeability, or the like disadvantage, impairing the properties of the toner.

For solving the aforementioned problems, various kinds of capsular toners have been disclosed which has a core-shell structure constituted of a core composed of a resin having a lower glass transition temperature and a shell having a higher glass transition temperature and enclosing the core. The capsulation can be conducted by suspension polymerization or interfacial polymerization. For example, Japanese Patent Application Laid-Open No. 5-113687 teaches encapsulation of a core binder containing a coloring material with a polyether-urea polymer shell by interfacial polymerization to prevent blocking of the toner particles and to improve the fixability of the toner. On the other hand, Japanese Patent Application Laid-Open No. 11-194531 discloses a capsular toner which is constituted of a core composed of a resin having a higher glass transition temperature and a shell composed of a resin having a lower glass transition temperature for enclosing the core to realize low-temperature fixability.

The microcapsules can be prepared by interfacial polymerization, suspension polymerization, emulsion polymerization, in-situ polymerization, coacervation (phase separation), in-liquid drying, or a like chemical method. In the interfacial polymerization method, two kinds of monomers or reactants are dissolved respectively in a dispersed phase and a continuous phase, and the monomers are allowed to polymerize at the interface of the two phases to form a shell wall. In the suspension polymerization method, a core substance is dispersed in a monomer in an aqueous medium, and the temperature of the system is raised to form a shell wall. In the emulsion polymerization method, a water-insoluble monomer is stirred in an aqueous medium containing an emulsifier dissolved therein to enclose the monomer in the emulsifier micelles, and to allow the monomer to polymerize in the micelles to form a shell wall. In the in-situ polymerization, a liquid or gaseous monomer and a catalyst, or two reactive substances are fed from the continuous phase or the nuclear particle side to cause reaction to form a shell wall. In the coacervation method (phase separation), a polymer solution containing core particles dispersed therein is allowed to separate into a high polymer concentration phase and a low polymer concentration phase to form a shell wall. In the in-liquid drying method, a core material is dispersed in a solution of a shell wall material, and the liquid dispersion is introduced into a liquid not miscible with the continuous phase of the liquid dispersion to form a multiple emulsion, and the medium dissolving the shell wall material is removed gradually to form a shell wall.

However, the microcapsules prepared by the aforementioned known method can contain a residue of the surfactant such as a suspension stabilizer and an emulsifier, or a polymerization reagent inside the capsule or in the capsule shell, which may cause a problem in some uses of the capsules. For example, the residue in the capsular toner can adversely affects electric properties or fluidity of the toner. In use for medicines, cosmetics, fertilizers, pesticides or the like, which will come into contact with human bodies or come to be scattered in natural environment, the residual matter limits strictly the use of the capsuled materials, or the surfactant or the polymerization reagent for the microcapsule production is strictly limited.

In the aforementioned conventional process for microcapsule production, the dispersion medium is also enclosed together with the core material in the microcapsule, lowering the core volume density in the total volume of the microcapsules. This will causes problems, for example, in the toner for a color copying machine requiring high brilliance and high resolution of the formed picture.

To solve such problems, a direct coating method is investigated in which a polymer for constituting the shell of the microcapsule is allowed to adsorb onto the core to cover the core surface directly. For example, “Solsperse” (trade name, ICI Co.) is produced by coating a pigment surface with a polymer with interposition of a dispersant which is capable of bonding to both the pigment and the polymer (“Shikizai Handobukku (Coloring material Handbook) page 428). Methods are disclosed in which the ionic properties of inorganic particles are decreased by a surface treatment, or a polar group is introduced into the polymer to allow the polymer to adsorb onto the inorganic particles to form a coating layer. Japanese Patent Application Laid-Open No. 8-286416 and so forth disclose a method in which the same monomer as that for the capsule is incorporated into cores to increase the affinity between the capsule and the core and the capsule shell is formed on the core surface. In these methods, however, the material for the core is limited, and the operation is complicated, disadvantageously.

Furthermore, the aforementioned conventional microcapsule production processes frequently employ an organic solvent for polymerization of the monomer or for dissolving the polymer. This prevents the use of the core which is soluble in the organic solvent. The large amount of the organic solvent used in the mass production tends to increase the load onto the equipment, human bodies, and environment.

In recent years, consumption of petroleum resources which will increase the carbon dioxide concentration in the atmospheric air is going to be curtailed for prevention of the global warming. For the same reason, plastic materials produced from a sugar formed by fixing the carbon dioxide from the atmospheric air are attracting attention.

Typical non-petroleum plastic materials include polyhydroxyalkanoates (hereinafter referred to as PHA), such as poly-3-hydroxy-n-butyric acid (hereinafter referred to as PHB), and a copolymer of 3-hydroxy-n-butyric acid and 3-hydroxy-n-valeric acid (hereinafter referred to occasionally as PHB/V), which are synthesized by Alcaligenes sp. or a like microorganism from a sugar and are accumulated in the form of granules in the cells. These materials can be used in various applications by melt processing thereof in a similar manner as conventional petroleum-originated plastics. Moreover, these plastic materials can be biologically degraded by microorganisms or living bodies and far less persistent in the environment and in living bodies advantageously. Further, these plastic materials are useful as functional materials such as medical materials owing to high biocompatibility thereof, and optical materials owing to optical activity caused by isotacticity thereof.

The use of the PHA having the aforementioned functionality in place of petroleum plastic materials will decrease the load to the environment and the living things, and will contribute the progress of material technology.

### SUMMARY OF THE INVENTION

An object of the present invention is to provide a capsular structure which encloses a core at a high concentration with few limitations of core materials by utilizing PHA having higher functionality with less load to the environment and living things.

Another object of the present invention is to provide a simple process for producing the capsular structure which does not use an additive such as a surfactant and a polymerization reagent which contaminates the microcapsule, or does not use an organic solvent.

Still another object of the present invention is to provide an electrophotographic capsular toner having low-temperature fixability and antiblocking properties as a use of the above capsular structure, and to also provide a process for production thereof.

For achieving the above objects, the inventors of the present invention made comprehensive investigation. In the investigation, an enzyme capable of synthesizing PHA (hereinafter referred to as “scl-PHA” (short chain length PHA)) having at least one monomer unit selected from a 3-hydroxypropionic acid unit, a 3-hydroxy-n-butyric acid, and a 3-hydroxy-n-valeric acid unit was immobilized on the surface of a core (core material). Thereto at least one selected from 3-hydroxypropionyl co-enzyme A, 3-hydroxybutyryl co-enzyme A, and 3-hydroxyvaleryl co-enzyme A was added to the immobilized enzyme to cause reaction. Thereby, scl-PHA was synthesized on the core surface to obtain a structure having a core and a shell of scl-PHA. The present invention has been accomplished based on the above findings.

The capsular structure of the present invention has a scl-PHA shell which is synthesized by an scl-PHA-synthesizing enzyme and covers at least a part of the core.

The process for producing the capsular structure having scl-PHA as an external shell of the present invention comprises immobilizing an scl-PHA-synthesizing enzyme on a core; and polymerizing, by action of the enzyme, at least one selected from 3-hydrioxy propionyl coenzyme A, 3-hydroxybutyryl coenzyme A, and 3-hyeroxyvaleryl coenzyme A to cover at least a part of the core with the scl-PHA.

The electrophotographic toner having low-temperature fixability and antiblocking properties of the present invention comprises the above capsular structure having a capsular structure shell formed from scl-PHA having a glass transition temperature suitable for the low-temperature fixability and antiblocking properties.

The process for producing the above electrophotographic toner is also provided.

Incidentally, the granular structure of the present invention should have a constitution having a polyhydroxyalkanoate coating on at least a part of the surface of the particles. However, the polyhydroxyalkanoate need not cover the entire surface of the particles, provided that the intended properties can be obtained. With the entire surface covered, as described above, a granular structure of microcapsule can be obtained which has a granule as the core and the coating layer of polyhydroxyalkanoate as the shell.

The present invention provides a granular structure having an outer shell formed from scl-PHA and enclosing a granular matter at a high density without limitation of the material of the granular matter. The present invention also provides a simple process for producing the above granular structure having excellent properties without contamination of a surfactant, a polymerization reagent, or the like without using an organic solvent. The present invention further provides an electrophotographic toner having low-temperature fixability and antiblocking properties by utilizing the above granular structure of the present invention. The present invention further provides a process for producing the above electrophotographic toner utilizing the above process for producing the granular structure of the present invention.

The above and other objects, effects, features and advantages of the present invention will become more apparent from the following description of embodiments thereof.

### DESCRIPTION OF THE PREFERRED EMBODIMENTS

The present invention is described below in more detail.

The present invention utilizes the in-vitro (noncellular) scl-PHA synthesis in which an scl-PHA-producing enzyme extracted from an scl-PHA-producing bacterium is fed with at least one of (R)-3-hydroxypropionyl CoA, (R)-3-hydroxybutyryl CoA, and (R)-3-hydroxyvaleryl CoA to synthesize scl-PHA.

The scl-PHA is synthesized by plural enzyme reaction systems in the cells of an scl-PHA-producing bacterium as follows. The biosynthesis of scl-PHA proceeds by enzymatic polymerization reaction of at least one of (R)-3-hydroxypropionyl CoA, (R)-3-hydroxybutyryl CoA, and (R)-3-hydroxyvaleryl CoA as the substrate which has been formed from various carbon sources through various metabolic pathways in vivo. The enzyme catalyzing this polymerization reaction is called an scl-PHA-synthesizing enzyme In the present invention. Of these, for example, the enzyme capable of synthesizing PHB is usually called a PHB-synthesizing enzyme (also called a PHB polymerase, or a PHB synthase).

Incidentally, “CoA” is abbreviation of coenzyme A, having the chemical structure shown by the chemical formula below.

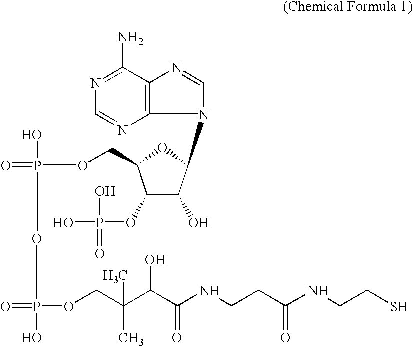

The present invention utilizes the last step of this enzyme reaction system to synthesize scl-PHA to polymerize at least one of (R)-3-hydroxypropionyl CoA, (R)-3-hydroxybutyryl CoA, and (R)-3-hydroxyvaleryl CoA by the scl-PHA-synthesizing enzyme.

Several examples are known of synthesis of scl-PHA in vitro. For example, Proc. Natl. Acd. Sci. USA, 92, 6279-6283 (1995) reports synthesis of PHB from 3-hydroxybutyryl CoA by action of a PHB-synthesizing enzyme derived from Alcaligenes eutrophus. Int. J. Biol. Macromol., 25, 55-60 (1999) reports PHB synthesis from 3-hydroxybutyryl CoA by action of PHB-syntesizing enzyme derived from Alcaligenes eutrophus. This paper further reports that PHB constituted only of the R-isomer of 3-hydroxy-n-butyric acid units was synthesized by stereoselectivity of the enzyme from racemic 3-hydroxybutyryl CoA. Macromol. Rapid Commun. 21, 77-84 (2000) also reports PHB synthesis in vitro by use of a PHB-synthesizing enzyme derived from Alcaligenes eutrophus. FEMS Microbiol. Lett., 168, 319-324 (1998) reports synthesis of PHB from 3-hydroxybutyryl CoA by PHB-synthesizing enzyme derived from Chromatium vinosum.

As shown above, several examples of synthesis of scl-PHA in vitro have been found. However, no report is found regarding the application thereof as the capsular structure of the present invention.

The microorganisms capable of producing the scl-PHA-synthsizing enzyme include those known as PHB- or PHB/V-producing bacteria. Known bacteria includes Aeromonas sp., Alcaligenes sp., Chromatium sp., Comamonas sp., Methylobacterium sp., Paracoccus sp., Pseudomonas sp., and so forth. The bacteria useful therefor includes also those isolated by the inventors of the present invention, including Burkholderia cepacia KK01, Ralstonia eutropha TB64, and Alcaligenes sp. TL2. The KK01 strain, the TB64 strain, and the TL2 strain have been deposited to National Institute of Bioscience and Human-Technology, Ministry of Economy, Trade, and Industry, Japan respectively with the deposit numbers: FERM BP-4235, FERM BP-6933, and FERM BP-6913.

In addition to the above wild strains, transformants are useful for production of the scl-PHA-synthesizing enzyme. The cloning, preparation of a manifestation vector, and preparation of transformant can be conducted according to a conventional method. The cloning of the gene of the scl-PHA-synthesizing enzyme was conducted with PHB synthase gene (phbc) of Alcaligenes eutophus. The inventors of the present invention has succeeded in cloning of phbc of Burkholderia cepacia KK01 strain (FERM BP-4235), and phbc of Ralstonia eutropha TB64 strain (FERM BP-6933). The transformant can be produced by introduction of the vector containing the phbc into the host. The vector containing the phbC can be derived by insertion of phbC into a plasmid vector, a phage vector, or the like. As the host, Escherichia coli is used frequently.

The aforementioned scl-PHA-producing bacteria may be employed singly or in combination of two or more thereof.

The culture medium for cultivating the microorganism employed in the present invention is suitably selected from those containing components necessary for multiplication of the microorganism, such as carbon sources, nitrogen sources, phosphorus sources, other inorganic components, and other organic components as necessary. Any culture medium can be used such as conventional natural culture medium (a meat-juice medium, a yeast extract, etc.) and synthetic culture mediums supplemented with nutrient sources, provided that the culture medium does not adversely affect the growth or existence of the microorganism.

Any method of cultivation of the microorganism may be employed, including liquid cultivation and solid cultivation, provided that the microorganism can multiply and produce the scl-PHA-synthesizing enzyme. Any cultivation process may be employed, including batch cultivation, fed-batch cultivation, semicontinuous cultivation, and continuous cultivation. Liquid batch cultivation may be conducted by supplying oxygen by shaking, or supplying oxygen by agitation-aeration with a jar-fermenter. The cultivation may be conducted by a multistage system connecting the above steps.

The cultivation temperature is not limited provided that the bacteria can multiply, ranging suitably from 14 to 40° C., preferably from 20 to 37° C.

In the case where a transformant is used which has been derived by employing a bacterium like Escherichia coli as the host and introducing therein a gene of scl-PHA-synthesizing enzyme, the aforementioned culture medium and cultivation method are useful. When a bacterium having been made resistant by a manifestation vector or the like is employed, an antibiotic substance such as kanamycin, ampicillin, tetracycline, chloramphenicol, and streptomycin may be added to the culture medium as necessary. When an inducing promoter is employed in the manifestation vector, an inducer corresponding to the promoter may be added to promote the manifestation; the inducer includes isopropyl-β-D-thiogalactopyranoside (IPTG), tetracycline, and indole-acrylic acid (IAA).

From the cultivated scl-PHA-producing bacteria, the scl-PHA-synthesizing enzyme can be extracted by crushing the liquid culture by means of a French press, by ultrasonic crushing, or by freezing-thawing; or by salting out by precipitating and recovering a protein component by addition of ammonium sulfate or a like salt. The extraction may be conducted after the bacterium mass is separated and removed from the liquid culture followed by concentration.

The scl-PHA-synthesizing enzyme is preferably purified before use, but may be used in a state of unpurified crude enzyme. In the case where the crude enzyme is used, bacterium components like protein other than the intended scl-PHA-synthesizing enzyme can be immobilized onto the core surface to lower the density of the immobilized scl-PHA-synthesizing enzyme, and to lower the activity of the scl-PHA-synthesizing enzyme by presence of the protease or the like contained in the bacterium mass, disadvantageously.

The scl-PHA-synthesizing enzyme can be isolated and purified by fragmentation of the nucleic acid components by a decomposition enzyme such as nuclease, and treatment by ion chromatography, adsorption chromatography, affinity chromatography, isoelectric fractionation, density gradient centrifugation, electrophoresis, molecular-sieving, two-phase separation, or a like method, singly or in combination thereof.

In particular, gene recombination protein can be purified simply by manifestation in a form of a fused protein having a tag of histidine residue or the like at the N-terminal or C-terminal and bonding the tag to an affinitive resin. The intended protein can be isolated from the fused protein by cutting with a protease such as trombin, and a blood coagulation factor Xa; or by cutting with dithiothreitol under reducing conditions when the tag contains an intein like pTYB1 (produced by New England Biolab Co.) as the manifestation vector. The fused protein which can be purified by affinity chromatography includes, in addition to the histidine tag, glutathione S-transferase (GST), chitin-bonded domain (CBD), maltose-bonded protein (MBP), and thioredoxin (TRX). The GST fused protein can be purified by a GST-affinitive resin. The scl-PHA-synthesizing enzyme may be used in combination with a stabilizer or activator, as necessary, such as a metal salt, glycerin, dithiothreitol, EDTA, and bovine serum albumin (BSA).

The activity of the scl-PHA-synthesizing enzyme can be measured by any of known conventional methods. One measurement method is detection of the CoA released in the process of polymerization of at least one of (R)-3-hyroxypropionyl CoA, (R)-3-hydorxybutyryl CoA, and (R)-3-hydroxyveleryl CoA by the catalytic action of the scl-PHA-synthesizing enzyme to produce scl-PHA by measurement of color development with 5,5′-dithio-bis(2-nitrobenzoic acid).

The scl-PHA-synthesizing enzyme can be immobilized onto the core by any method depending on the kind and structure of the core material, and application of the produced capsular structure. Of the immobilization methods, ion adsorption, or hydrophobic adsorption is simple.

The enzyme protein of the scl-PHA-synthesizing enzyme or the like is a polypeptide formed by the sequence of many amino acids, and exhibits properties of an ion adsorbent owing to the amino acids having free ionic groups such as lysine, histidine, arginine, aspartic acid, and glutamic acid, and also has properties of a hydrophilic adsorbent of an organic high polymer owing to the amino acids having a free hydrophobic group such as alanine, valine, leucine, isoleucine, methionine, tryptophan, phenylalanine, and proline. Therefore, the enzyme protein can be adsorbed by an ionic, hydrophobic, or ionic-and-hydrophobic solid.

The core material which immobilizes the scl-PHA-synthesizing enzyme mainly by ion adsorption is a material having an ionic functional group on the surface. The ion-adsorbent core material includes clay minerals such as kaolinite, bentonite, talc, and mica; metal oxides such as alumina, and titanium dioxide; insoluble inorganic salts such as silica gel, hydroxyapatite, and calcium phosphate gel; inorganic pigments containing the above clay mineral, metal oxide, or insoluble inorganic salt as a main component; and organic polymers having ionic functional group such as ion-exchange resin, chitosan, and polyaminostyrene.

The core material which immobilizes the scl-PHA-synthesizing enzyme mainly by hydrophobic adsorption is a material having a nonpolar surface. The hydrophobic adsorbent core material includes styrene type polymers, acrylic polymers, methacrylic polymers, vinyl ester polymers, vinyl polymers, and other organic polymers having no ionic functionality on the surface or having a hydrophobic functional group on the surface; organic pigments such as azo pigments having plural aromatic rings, phthalocyanine pigments and anthraquinone pigments having a condensed polycyclic ring; and carbon black.

The immobilization of the scl-PHA-synthesizing enzyme by ionic adsorption or hydrophobic adsorption can be achieved by mixing the enzyme and the cores together in a prescribed solution. In the mixing, the reaction vessel is preferably shaken with a suitable intensity for uniform adsorption of the scl-PHA-synthesizing enzyme on the core surface.

The ionic adsorption and the hydrophobic adsorption of the scl-PHA-synthesizing enzyme on the cores can be controlled to some extent by selecting conditions of the solution such as pH, salt concentration, temperature, or the like. Therefore, the solution is preferably adjusted within the range in which the scl-PHA-synthesizing enzyme can be active.

The solution conditions may be set to be suitable for the adsorption by preliminarily testing the electric charging state or the hydrophobicity of the cores and the scl-PHA-synthesizing enzyme by electrophoresis or the wetting angle measurement.

The solution conditions may be decided by directly measuring the adsorption quantity of the scl-PHA-synthesizing enzyme onto the cores. The adsorption quantity can be measured, for example, by adding a known amount of the scl-PHA-synthesizing enzyme into a core-containing solution and measuring the concentration of the unadsorbed scl-PHA-synthesizing enzyme after the adsorption reaction, and taking the concentration difference.

With a core material which is not sufficiently capable of immobilizing the scl-PHA-synthesizing enzyme by ion adsorption or hydrophobic adsorption, the enzyme may be bonded to the core by covalent bonding in consideration of ease of the operation and possibility of loss of enzyme activity. The covalent bonding method includes a method of diazotizing the core material having an aromatic amino group and diazo-coupling the enzyme; a method of forming a peptide bonding between the core material having a carboxyl group or an amino group and the enzyme; a method of causing alkylation between the halogen-group-containing core material and the amino group of the enzyme; a method of causing a reaction of a core polysaccharide activated by cyan bromide with the amino group of the enzyme; a method of crosslinking the amino group of the core and the amino group of the enzyme; a method of causing a reaction of a carboxyl- or amino-group-containing core with the enzyme in the presence of an aldehyde- or ketone-group-containing compound and an isocyanide compound; a method of causing exchange reaction between a disulfide-group-containing core and the thiol of the enzyme; and so forth.

The scl-PHA-synthesizing enzyme may be immobilized by affinity-adsorption onto a core having a ligand. Any ligand may be employed therefor which enables affinity adsorption by retaining the enzymatic activity of the scl-PHA-synthesizing enzyme. The scl-PHA-synthesizing enzyme may also be immobilized such that a biopolymer like a protein is bonded thereto and the bonded biopolymer is allowed to be adsorbed by affinity adsorption. The bonding between the scl-PHA-synthesizing enzyme and the biopolymer may be formed by gene recombination, or by chemical reaction. For example, as described later in Examples, glutathione S-transferase is fused to the scl-PHA-synthesizing enzyme by transformation, and the fused protein is affinity-adsorbed by sepharose having introduced glutathione which is a ligand for the glutathione S-transferase to immobilize the scl-PHA-synthesizing enzyme.

The amount of the enzyme immobilized to the core is suitably decided depending on the layer thickness of the coating shell of the capsular structure and the surface area of the core. Preferably the amount to be immobilized is in the range from 10 U to 1000 U, more preferably from 50 U to 500 U, where U means a unit of the amount of the enzyme which releases 1 μmol of CoA in one minute.

The immobilized enzyme prepared as described above may be used as it is, or may be used after treatment such as freeze-drying.

The material of the core is not limited, provided that the core is capable of immobilizing the scl-PHA-synthesizing enzyme by the aforementioned method or a like method. The material may be selected suitably from organic high molecular substances and inorganic solid substances. The core material may be a single substance or a mixture of substances.

In the present invention, the capsular structure is produced in water as the solvent without using an organic solvent. Therefore, a material which is poorly dispersible in an organic solvent but is dispersible in an aqueous solvent, like a hydrophilic inorganic pigment, can be used as the core material. A material which is soluble in an organic solvent may be used also as the core material.

Further, in the present invention, the core material is preferably a biodegradable plastic material to make effective the biodegradability of the capsule shell formed from the scl-PHA-synthesizing enzyme. The biodegradable plastic material may be scl-PHA produced by a microorganism, or may be a commercial biodegradable plastic material such as “Ecostar”, and “Ecostar Plus” (Hagihara Kogyo K.K.); “Biopole” (I.C.I Japan Co.); “Ajicoat” (Ajinomoto Co.); “Placcel”, and “Polycaprolactone” (Daicel Chemical Ind., Ltd.); “Sholex”, and “Bionolle” (Showa Denko K.K.); “Lacty” (Shimadzu Corp.); and “Lacea” (Mitsui Chemical Co.).

As the core material, pigments are effectively used in the present invention. The useful pigments include known organic and inorganic pigments. The black pigments include inorganic pigments such as carbon black, and triiron tetraoxide; and organic pigments such as cyanine black. The white pigments include zinc white, titanium oxide, antimony white, and zinc sulfate. The yellow pigments include inorganic pigments such as chrome yellow, cadmium yellow, yellow iron oxide, titanium yellow, and ocher. The pigments include slightly soluble metal salts (azo-lakes) of acetoacetic anilide type monoazopigments such as Hanza Yellow G (C.I. No. Pigment Yellow 1 (hereinafter the term “C.I. No.” being omitted)), Hanza Yellow 10G (Pigment Yellow 3), Hanza Yellow RN (Pigment Yellow 65), Hanza Brilliant Yellow 5GX (Pigment Yellow 74), Hanza Brilliant Yellow 10GX (Pigment Yellow 98), Permanent Yellow FGL (Pigment Yellow 97), Simula Lake Fast Yellow 6G (Pigment Yellow 133), Rionol Yellow K-2R (Pigment Yellow 169); acetoacetic anilide disazo pigments such as Disazo Yellow G (Pigment Yellow 12), Disazo Yellow GR (Pigment Yellow 13), Disazo Yellow 5G (Pigment Yellow 14), Disazo Yellow 8G (Pigment Yellow 17), Disazo Yellow R (Pigment Yellow 55), and Permanent Yellow HR (Pigment Yellow 83); condensed azo pigments such as Chromophthal Yellow 3G (Pigment Yellow 93), Chromophthal Yellow 6G (Pigment Yellow 94), and Chromophthal Yellow GR (pigment Yellow 95); benzimidazolone type monoazo pigments such as Hostaperm Yellow H3G (Pigment Yellos 154), Hostaperm Yellow H4G (Pigment Yellow 151), Hostaperm Yellow H2G (Pigment Yellow 120), Hostaperm Yellow H6G (Pigment Yellow 175), and Hostaperm Yellow HLR (Pigment Yellow 156); isoindolinone pigments such as Irgazine Yellow 3RLTN (Pigment Yellow 110), Irgazine Yellow 2RLT, Irgazine Yellow 2GLT (Pigment Yellow 109), Fastogen Super Yellow GROH (Pigment Yellow 137), Fastogen Super Yellow GRO (Pigment Yellow 110), and Sundrin Yellow 6GL (Pigment Yellow 173); threne pigments such as Flavanthrone (Pigment Yellow 24), Anthramilimidine (Pigment Yellow 108), phthaloylamide type anthraquinine (Pigment Yellow 123), and Heriofasto Yellow E3R (Piment Yellow 99); metal complex pigments such as azo nickel complex pigments (Pigment Green 10), nitroso nickel complex pigments (Pigment Yellow 153), azo methine type copper complex pigments (Pigment Yellow 117); and quinophthalone pigments such as phthalimidoquinophthalone pigment (Pigment Yellow 138). The magenta pigments include inorganic pigments such as cadmium red, red iron oxide, vermilion, minium, and antimony red. The pigments also include azo lake pigments such as Brilliant Carmine 6B (Pigment Red 57:1), Lake Red (Pigment Red 53:1), Permanent Red F5R (Pigment Red 48), Lithol Red (Pigment Red 49), Persian Orange (Pigment Orange 17), Kurosei Orange (Pigment Orange 18), Helio Orange TD (Pigment Orange 19), Pigment Scarlet (Pigment Red 60:1), Brilliant Scarlet G (Pigment 64:1), Helio Red RMT (Pigment Red 51), Bordeaux 10B (Pigment Red 63), and Helio Bordeaux BL (Pigment Red 54). Insoluble azo pigments (monoazo, disazo, and condensed azo) include Para Red (Pigment Red 1), Lake Red 4R (Pigment Red 3), Permanent Orange (Pigment Orange 5), Permanent FR2 (Pigment Red 2), Permanent Red FRLL (Pigment Red 9), Permanent Red FGR (Pigment Red 112), Brilliant Carmine BS (Pigment Red 114), Permanent Carmine FB (Pigment Red 5), P.V. Carmine HR (Pigment Red 150), Permanent Carmine FBB (Pigment Red 146), Nova Perm Red F3RK-F5RK (Pigment Red 170), Nova Perm Red HFG (Pigment Orange 38), Nova Perm Red HF4B (Pigment Red 187), Nova Perm Orange HL.HL-70 (Pigment Orange 36), P.V. Carmine HF4C (Pigment Red 185), Hostabahm Brown HFR (Pigment Brown 25), Balkan Orange (Pigment Orange 16), Pyrazolone Orange (Pigment Orange 13), and Pyrazolone Red (Pigment Red 38). The condensed azo pigments include Chromophthal Orange 4R (Pigment Orange 31), Chromophthal Scarlet R (Pigment Red 166), and Chromophthal Red BR (Pigment Red 144). The condensed polycyclic pigments include anthraquinone pigments such as pyranthrone Orange (Pigment Orange 40), Anthanthrone Orange (Pigment Orange 168), and Dianthraquinonyl Red (Pigment Red 177). Thioindigo pigments include Thioindigo Magenta (Pigment Violet 38), Thioindigo Violet (Pigment Violet 36), and Thioindigo Red Pigment Red 88). The perinone pigments includes Perinone Orange (Pigment Orange 43). The perylene pigments include Perylene Red (Pigment Red 190), Perylene Vermilion (Pigment Red 123), Perylene Maloon (Pigment Red 179), Perylene Scarlet (Pigment Red 149), and Perylene Red (pigment Red 178). The quinacridone pigments include Quinacridone Red (Pigment Violet 19), Quinacridone Magenta (Pigment Red 122), Quinacridone Maloon (Pigment Red 206), and Quinacridone Scarlet (Pigment Red 207). The condensed polycyclic pigments further include pyrrocoline pigments, red fluorubin pigments, and dyeing lake pigments (Water-Soluble Dye+Precipitant→Deposition on Lake).

The cyan pigments include inorganic pigments such as ultramarine, indigo blue, cobalt blue, and Celrian blue. The phthalocianine pigments include Fastogen Blue BB (Pigment Blue 15), Sumiton Cyanine Blue HB (Pigment Blue 15), Cyanine Blue 5020 (Pigment Blue 15:1), Sumika Print Cyanine Blue GN-O (Pigment Blue 15), Fast Sky Blue A-612 (Pigment Blue 17), Cyanine Green GB (Pigment Green 7), Cyanine Green S537-2Y (Pigment Green 36), and Sumiton Fast Violet RL (Pigment Violet 23). The threne pigments include Indanthrone Blues (PB-60P, PB-22, PB-21, and PB-64), and Methyl Violet Phosphomolybdate Lake (PV-3, a basic dye lake pigment). The extender pigments include barite powder, barium carbonate, clay, silica, white carbon, talc, and alumina white. Processed pigments produced by coating the surface of the aforementioned pigment with a resin are also useful.

The electrophotographic capsular toner employing the capsular structure of the present invention may have, as the core material, a conventional toner particles, or particles formed from a material used conventionally as a toner.

The materials for producing the toner of the present invention include binder resins, coloring materials, electric charge controlling agents, and magnetic materials.

Any usual binder resin for toner production is useful without limitation in the present invention. The binder resin includes styrenic polymers, polyester polymers, epoxy polymers, polyolefin polymers, and polyurethane polymers. They are used singly or in combination of two or more thereof. The styrenic polymer includes copolymers of styrene and a (meth)acrylate ester, and copolymers thereof with another copolymerizable monomer; copolymers of styrene and a diene monomer (butadiene, isoprene, etc.), and copolymers thereof with another copolymerizable monomer. The polyester polymers include polycondensates of an aromatic dicarboxylic acid and an alkylene oxide adduct of aromatic diol. The epoxy polymers include reaction products of an aromatic diol and epichlorohydrin, and modified products thereof. The polyolefin polymers include polyethylene, polypropylene, and copolymer with another copolymerizable monomer. The polyurethane polymers include polyadducts of an aromatic diisocyanate and an alkylene oxide adduct of aromatic diol.

The binder resin can be produced by a conventional process for toner production, the process including crushing of a polymer, and polymerization by suspension polymerization, emulsion polymerization, and dispersion polymerization. Depending on the polymerization process, a crosslinking agent, or a polymerization initiator may be used.

The coloring material, the charge controller, the magnetic material, and the like additive may be added to the binder resin during the production process, or to the produced binder resin by swelling or mechanical implantation.

Any coloring material may be used which is employed conventionally in toner production without limitation. The pigment as the coloring material are mentioned above. When a binder resin is used, a dye may be used as the coloring material. The useful dyes include Dia Resins Yellow 3G, Yellow-F, Yellow-H2G, Yellow-HG, Yellow-HC, Yellow HL, Orange-HS, Orange-G, Red-GG, Red-S, Red-HS, Red-A, Red-K, Red-H5B, Violet-D, Blue-J, Blue-G, Blue-N, Blue-K, Blue-P, Blue-H3G, Blue-4G, Green-C, and Brown-A produced by Mitsubishi Chem. Ind. Ltd.; Deep Blue SOT dyes Yellow-1, Yellow-3, Yellow-4, Orange-1, Orange-2, Orange-3, Scarlet-1, Red-1, Red-2, Red-3, Brown-2, Blue-1, Blue-2, Violet-1, Green-1, Green-2, Green-3, Black-1, Black-4, Black-6, and Black-8, produced by Hodogaya Chem. Ind. Ltd.; Sudan dyes Yellow-146, Yellow-150, Orange-220, Red-290, Red-380, Red-460, and Blue-670, produced by BASF; Oil Blacks, and Oil Colors Yellow-3G, Yellow-GG-S, Yellow-#105, Orange-PS, Orange-PR, Orange-#201, Scarlet-#308, Red-5B, Brown-GR, Brown-#416, Green-BG, Green-#502, Blue-BOS, Blue-IIN, Black-HBB, Black-#803, Black-EB, and Black-EX, produced by Orient Chem. Ind., Ltd.; and Sumiplasts Blue-GP, Blue-OR, Red-FB, Red-3B, Yellow-FL7G, and Yellow-GC, produced by Sumitomo Chem. Ind., Ltd.; Kayaron, Polyester Black EX-SF300, Kayaset Red B, and Blue A-2R, produced by Nippon Kayaku Co., Ltd.

The aforementioned dyes and pigments may be used singly or in combination of two or more thereof. In consideration of environmental protection and safety to human bodies, food dyes are suitably used.

The content of the above coloring material in the capsular toner may be selected in a wide range depending on the intended coloring effect, and other conditions. Usually the content ranges from 0.1 to 15 parts by mass, preferably from 1.0 to 10 parts by mass based on 100 parts by mass of the binder resin. At the coloring material content of less than 0.1 parts by mass, the hiding power of the toner may be insufficient. For coloring of an OHP sheet for OHP (overhead projector), the coloring material at a content higher than 15 parts by mass may decrease the clarity of the light having transmitted through the sheet depending on the kind of the coloring material.

The charge controlling agent is not limited: any positive charge controlling agent or any negative charge controlling agent which is usually used in production of a toner may be used. The charge controlling agents include nigrosine dyes, triphenylmethane dyes, quaternary ammonium salts, amine compounds, imine compounds, metal compounds of salicylic acid and alkylsalicylic acids, metal-containing monoazo dyes, compounds having a carboxylyl group or a sulfoxyl group, humic acids such as nitorfumine and humate salts.

The charge controlling agent is incorporated into the capsular toner at a content usually ranging from 0.1 to 50 mass %, preferably from 0.3 to 30 mass % based on 100 parts by mass of the binder resin. At the content lower than 0.1 mass %, the charging is insufficient, whereas at the content higher than 50 mass %, the charge stability of the toner is insufficient.

The capsular toner of the present invention may contain a magnetic material in the core to serve as a magnetic toner. With this type of magnetic toner, the magnetic material may be allowed to serve also as the coloring material. The magnetic material used therefor includes iron oxides such as magnetite, hematite, and ferrite; metals such as iron, cobalt, and nickel; alloys of the above metal with another metal like aluminum, cobalt, copper, lead, magnesium, tin, zinc, antimony, beryllium, bismuth, cadmium, calcium, manganese, selenium, titanium, tungsten, and vanadium; and mixtures thereof. The magnetic material has an average particle diameter of preferably not more than 2 μm, more preferably in the range from about 0.1 to about 0.5 μm.

The above magnetic material is contained at a content ranging usually from 20 to 200 parts by mass, more preferably from 40 to 150 parts by mass based on 100 parts by mass of the binder resin in the capsular toner.

The core of the capsular structure of the present invention is described above for use as the capsular toner. Since the core of the capsular toner is encapsulated by scl-PHA, the core of the capsular toner need not have a glass transition temperature within the range from 40 to 75° C. required for usual low-temperature fixing toners, but may be in the range, for example, from 20 to 40° C. or from 75 to 120° C. for effective use.

The particle diameter of the core of the capsular structure employed in the present invention is preferably not less than 0.01 μm for producing the capsular structure, but is not limited thereto. The particle diameter is preferably not more than about 1 mm for uniform adsorption of the scl-PHA-synthesizing enzyme on the particle surface, although no upper limit is prescribed to the particle diameter.

For use as the capsular toner, the core has a weight-average particle diameter ranging preferably from 3 to 8 μm to achieve high image quality. The capsular toner has a weight-average particle diameter ranging preferably from 3 to 10 μm. The capslued toner having a weight-average of less than 3 μm is liable to lower the transfer efficiency and to increase the amount of residual toner on the photosensitive member, and tends to cause nonuniformity of the formed image due to fogging and transfer failure disadvantageously. On the other hand, the capsular toner having a weight-average particle dimater of more than 10 μm tends to cause scattering of the letters and line images.

In the process of producing the capsular structure of the present invention, uniform core particle diameters will give relatively uniform particle diameters of the formed capsular structure, and moreover, nonuniform diameters and irregular shapes of the cores can also give nearly uniform capsules. Therefore, the diameters and shapes of the core particles need not be uniform.

The core particle diameter and the core particle diameter distribution can be measured, for example, by means of a Coulter Counter (Model TA-II) or Coulter Multisizer (manufactured by Coulter Co.).

Normally, in the case where microcapsule like that of the present invention is produced in a water medium with a hydrophobic core material like an organic pigment, the cores are liable to aggregate during the capsule formation. However, in the process of the present invention, scl-PHA-synthesizing enzyme is adsorbed by the solid particles, whereby the hydrophobic solid particles are dispersed in the water medium by the electric repulsion and/or steric repulsion by ionic functional group of the enzyme protein to facilitate the encapsulation of the hydrophobic cores.

In the step of immobilizing the enzyme on the cores, the cores are preferably dispersed to some extent. The dispersion is preferably conducted by a mechanical method such as stirring and ultrasonic treatment for achieving the feature of the present invention that the capsules can be formed without employing a surfactant. However, a conventional surfactant may be used for core dispersion within ranges of the composition and the concentration that do not adversely affect the enzyme activity, provided that the surfactant causes no problem in its application.

In the synthesis of scl-PHA by the aforementioned scl-PHA-synthesizing enzyme immobilized by the cores, the monomer used are (R)-3-hydroxypropionyl CoA, (R)-3-hydroxybutyryl CoA, or (R)-3-hydroxyvaleryl CoA. The (R)-3-hyroscybutyryl CoA is commercially available from Sigma Aldrich Japan Co., or other companies. The above monomers can be synthesized for the use by in-vitro synthesis employing an enzyme, in-vivo synthesis employing a microorganism, a plant, or another living body, or chemical synthesis. For example, the enzymatic synthesis is a general method for the substrate synthesis. 3-Hydroxyacyl CoA can be synthesized by using commercial acyl CoA synthetase (acyl CoA ligase E.C.6.2.1.3) according to the enzymatic synthesis method (Eur. J. Biochem., 250, 432-439 (1997); Appl. Microbiol. Biotechnol. 54, 37-43 (2000), etc.) through the process shown by the formula below:

### Acyl CoA Synthetase

3-Hydroxyalkanoic acid+CoA→3-Hydroxyacyl CoA

In the present invention, at least one of (R)-3-hydroxypropionyl CoA, (R)-3-hydroxybutyryl CoA, and (R)-3-hydroxyvaleryl CoA is added to an aqueous reaction medium containing the cores having the scl-PHA-synthesizing enzyme immobilized thereon, and is allowed to polymerize the above hydorxyalkanoic acid by adjusting the reaction conditions, thereby coating the cores with the scl-PHA to form a capsular structure having scl-PHA as the outer shell.

The aqueous reaction solution for the above reaction is not limited provided that the solution is adjusted to obtain the activity of the scl-PHA-synthesizing enzyme. For example, the solution is adjusted to have a pH usually from 5.5 to 9.0, preferably from 7.0 to 8.5. The conditions may be outside the above range depending on the optimum pH or pH-stability of the scl-PHA-synthesizing enzyme employed.

The buffer solution is suitably selected depending on the prescribed pH range to obtain the activity of the scl-PHA-synthesizing enzyme employed. The buffer solution may be selected from those generally used in biochemical reactions, such as acetate buffers, phosphate buffers, potassium phosphate buffers, 3-(N-morpholino)propanesulfonate (MOPS) buffers, N-tris(hydroxymethyl)methyl-3-aminopropanesulfonate (TAPS) buffers, Tris-hydrochloric acid buffers, glycine buffers, and 2-(cyclohexylamino)ethanesulfonate (CHES) buffers. The concentration of the buffer solution is not limited provided that the activity of the scl-PHA-synthesizing enzyme employed can be achieved, usually ranging from 5.0 mM to 1.0 M, preferably from 0.1 M to 0.2 M. The reaction temperature is selected to be suitable for the scl-PHA-synthesizing enzyme employed, usually ranging from 4 to 50° C., preferably from 20 to 40° C. The reaction temperature may be outside the above range depending on the optimum temperature or heat resistance of the scl-PHA-synthesizing enzyme employed. The reaction time is selected usually in the range from one minute to 24 hours, preferably from 30 minutes to 3 hours, depending on the stability of the scl-PHA-synthesizing enzyme employed. The concentration of at least one of (R)-3-hydroxypropionyl CoA, (R)-3-hydroxybutyryl CoA, and (R)-3-hydroxyvaleryl CoA (total concentration for enzyme combination) in the reaction solution is selected suitably to achieve the activity of the scl-PHA-synthesizing enzyme employed, ranging usually from 0.1 mM to 1.0 M, preferably from 0.2 mM to 0.2 M. At a higher concentration of the at least one of (R)-3-hydroxypropionyl CoA, (R)-3-hydroxybutyryl CoA, and (R)-3-hydroxyvaleryl CoA, the pH of the reaction system tends to become lower. Therefore, when at least one of (R)-3-hydroxypropionyl CoA, (R)-3-hydroxybutyryl CoA, and (R)-3-hydroxyvaleryl CoA is employed at a higher concentration, the aforementioned buffer solution is preferably used at a higher concentration.

In the production of the capsular structure, at least one of (R)-3-hydroxypropionyl CoA, (R)-3-hydroxybutyryl CoA, and (R)-3-hydroxyvaleryl CoA is preferably fed uniformly to the scl-PHA-synthesizing enzyme immobilized onto the core surface. Therefore the reaction vessel is preferably shaken at a suitable intensity.

The coating of the above capsular structure obtained according to the present invention with the scl-PHA can be confirmed by composition analysis by gas chromatography combined with shape observation by electron microscopy; determination of the structure by mass spectra of the constituting layers by time-of-flight type secondary ion mass spectrum apparatus (TOF-SIMS) and ion sputtering. Another direct and simple method of the confirmation is combination of Nile Blue-A staining and fluorescence microscopy. This method has been developed by the inventors of the present invention. The inventors of the present invention comprehensively investigated the simple method for confirming the synthesis of scl-PHA in vitro by scl-PHA-synthesizing enzyme. As the result, the inventors found that Nile Blue-A is useful for judging the scl-PHA synthesis in vitro. The Nile Blue-A is a reagent which comes to bond specifically to scl-PHA to emit fluorescence. The Nile Blue A is reported to be effective for simplified confirmation of the scl-PHA production in vivo (Appl. Environ. Microbiol., 44, 238-241 (1982)). The inventors of the present invention found that this Nile Blue-A is useful also in vitro in confirmation of scl-PHA synthesis. In this method of confirmation, a Nile Blue-A solution is mixed at a prescribed concentration with a reaction solution containing scl-PHA, and the mixture is observed with a fluorescence microscope while applying an exciting light of a prescribed wavelength to detect the fluorescence emitted from only the synthesized scl-PHA to simply judge the scl-PHA synthesis in vitro. The above method enables direct observation and evaluation of the scl-PHA covering the surface of the cores in the production of the structure of the present invention, provided that the core itself employed does not emit fluorescence under the above condition.

The thickness of the scl-PHA outer shell of the capsular structure is controllable by controlling the reaction conditions such as the reaction time, the 3HB-CoA concentration, the enzyme concentration, and temperature to some extent within the range from 0.01 to 10 μm. For electrophotographic capsular toner, the thickness of the scl-PHA shell ranges preferably from about 0.1 to about 2 μm, since thickness of the shell of less than 0.1 μm results in low fixability, and thickness of more than 2 μm tends to cause offset.

In the process for producing the capsular structure of the present invention, the thickness of the scl-PHA shell of the cores in a liquid dispersion can be made uniform to some extent. Therefore, the particle diameter of the capsular structure can be made uniform to some extent by making uniform the diameters of the cores. Moreover, the cores having nonuniform particle size and irregular shape can be coated with a shell of uniform thickness to some extent.

In the capsular structure of the present invention, the scl-PHA coating layer can be formed directly on the surface of the cores. Therefore, the density of the cores can be made higher in the capsular structure. The core density depends on the core diameters and the layer thickness of the scl-PHA coating shell, and is controllable within the range from 10 to 95 volume % according to the object.

The layer thickness of the scl-PHA coating can be measured by solidifying the capsular structure with an epoxy resin, slicing into an ultrathin piece, staining it with ruthenium tetraoxide, osmium tetraoxide, or the like, and observing it by transmission electron microscopy; or by measuring the difference of particle diameters before and after the capsule formation by means of a particle size tester such as Coulter Counter Multisizer (manufactured by Coulter Co.).

In the capsular structure of the present invention, the molecular weight of the scl-PHA constituting the coating shell can be controlled in the range of Mn (number-average molecular weight) from 1,000 to 10,000,000 (in terms of polystyrene) by changing the reaction conditions such as the reaction time, the 3HB-CoA concentration, the enzyme concentration, the temperature, and so forth. For use as an electrophotographic capsular toner, for example, the molecular weight is preferably in the range from about 3,000 to 1,000,000.

The glass transition temperature of scl-PHA of the capsule shell can be controlled to some extent by controlling the molecular weight. For use as an electrophotographic capsular toner, the glass transition temperature of the scl-PHA capsular shell ranges preferably from 45 to 75° C., preferably from 50 to 70° C. The toner particles having the shell of glass transition temperature lower than 45° C. tend to cause fusion-bonding or blocking during storage, whereas the toner having the shell of glass transition temperature of higher than 75° C. has low fixability.

The molecular weight of the scl-PHA can be measured, for example, by dissolving the scl-PHA of the capsular structure shell in chloroform, and subjecting the solution to GPC measurement (Gel Permeation Chromatography) by assuming that the core is insoluble in chloroform.

The glass transition temperature can be measured, for example, by a differential scanning calorimeter of an internal-heating input compensation type like the apparatus of Model DSC-7 manufactured by Perkin Elmer Co. according to ASTM D3418-82.

The scl-PHA constituting the shell of the capsular structure of the present invention is biodegradable. Therefore the capsular structure enclosing a suitable cores is safe to living things, and does not cause pollution when it is discarded in the environment. The capsular structure is useful also for agricultural chemicals and medical preparations since the capsule shell decomposes gradually in the natural world or in a living body to exhibit controlled-release properties.

The scl-PHA constituting the shell of the capsular structure of the present invention is an isotactic polymer composed only of an R-isomer, and will be useful as an optical material.

The capsular structure of the present invention can be produced without using a surfactant by the above-mentioned process, and is not contaminated with the surfactant. The contamination of the capsular structure by 3HB-CoA or the salt of the buffer solution is extremely slight. The contaminating 3HB-CoA and the buffer solution salt are biologically harmless, and can be readily be washed off, not adversely affecting the use of the capsule.

The production process of the present invention can be conducted by an enzymatic reaction only, under mild reaction conditions such as temperature without high-speed stirring for emulsifying or suspending, by simply adding an enzyme and a monomer to the core.

Since the process of the present invention does not require an organic solvent, the process does not require a tightly closable vessel, an air-exhauster, or a complicated waste solution treatment equipment. Therefore, the production cost can be lower, the production scale can readily be enlarged, and the load to the human bodies and the environment is less.

The capsular structure produced by the process of the present invention can be used in a state of the reaction solution without treatment as an aqueous dispersion, or can be used after recovery by mild centrifugation or suction filtration, by dispersing it in another aqueous solution. Otherwise, the capsular structure may be used as a solvent-dispersion by dispersing the recovered capsular structure in an organic solvent not dissolving the scl-PHA, or solvent substitution to an organic solvent not dissolving the scl-PHA. The capsular structure can be washed by the methods mentioned above.

The capsular structure can be prepared in a powder state by mild centrifugation or suction filtration to obtain a wet cake and subsequent drying by vacuum drying, or jet mill drying when the particle size is large, or spray drying when the particle size is small.

The diameters of the capsular structure particles can be uniformized to some extent by using cores having a uniform size. To obtain more uniform size of the particles, the produced capsular structure particles may be classified further.

The above capsular structure may be used combinedly with an additive or may be subjected to secondary processing or chemical modification for the purpose.

For use as an electrophotographic capsular toner, for example, an external additive may be added for improving fluidity, electric chargeability, developability, and durability. Any known toner additive may be used as the external additive, specifically including fine powdery materials such as silica, titanium oxide, and alumina. Silica, for example, has preferably a BET surface area of not less than 30 m²/g, more preferably not less than 300 m²/g. The amount of addition of the fine powdery silica ranges preferably from 0.01 to 8 parts by mass, more preferably 0.1 to 5 parts by mass based on 100 parts of the capsular toner. The fine powdery silica used therefor is preferably pretreated with a treating agent such as a silicone varnish, a modified varnish, a silicone oil, a modified silicone oil, a silane coupling agent, a functionalized silane coupling agent, and other organic silicon compounds. The treating agents may be used in combination of two or more thereof.

The electrophotographic capsular toner of the present invention preferably contains an inorganic powdery matter such as zinc oxide, aluminum oxide, cobalt oxide, manganese dioxide, strontium titanate, and magnesium titanate for improving the developability and durability.

The electrophotographic capsular toner of the present invention may further contain a powdery lubricant such as fluororesins like Teflon, and polyvinylidene fluoride; fluorine compounds like carbon fluoride; fatty acid metal salts like zinc stearate; fatty acids; fatty acid derivatives like fatty acid esters; and molybdenum sulfate.

The electrophotographic capsular toner of the present invention can be used singly as a non-magnetic one-component developer, as a non-magnetic component of a two-component developer in combination with a magnetic carrier, or singly as a magnetic one-component developer, and as other known toners. The carrier for the two-component developer may be any known carrier, specifically including particles of metals such as surface-oxidized or unoxidized iron, nickel, cobalt, manganese, chromium, and rare earth metals; alloys of these metals; and oxides of these metals. The carrier has an average particle size ranging from 20 to 300 μm. The carrier in the present invention is preferably coated partly or entirely with a material like a styrenic resin, an acrylic resin, a silicone resin, a fluoroplastic, or a polyester resin. The carrier particles in the present invention may be coated with scl-PHA.

The capsular structure, the application thereof, and the production process thereof are not limited to those mentioned above.

### EXAMPLES

The present invention is descried more specifically by reference to Examples. The Examples below illustrate best modes of the present invention without limiting the technical scope of the invention thereto. In Examples, the term “parts” signifies “parts by mass” unless otherwise mentioned.

<Preparation of Transformant Having PHB-Synthesizing Enzyme Productivity>

A TB64 strain bacterium was cultivated overnight in 100 mL of an LB culture medium (1% polypeptone, 0.5% yeast extract, 0.5% sodium chloride, pH 7.4) at 30° C. Then the chromosomal DNA was separated and recovered according to Marmur's method. The obtained chromosomal DNA was partially degraded by a restriction enzyme, Sau3AI. The vector used was pUC18. This was cleaved by a restriction enzyme, BamHI, and subjected to dephosphorylation treatment (Molecular Cloning, Vol.1, p.572, 1989, published by Cold Spring Harbor Laboratory), and then connected to the a partial breakdown fragment of the chromosomal DNA having been prepared above by Sau3AI by means of a DNA Ligation Kit Ver. II (Takara Shuzo Co.). By use of this connected DNA fragment, the HB101 strain of Escherchia coli was transformed to obtain a chromosomal DNA library of the TB64 strain.

Then, phenotypic screening was conducted to obtain a DNA fragment containing the gene of a PHB-synthesizing enzyme group of the TB64 strain. An LB culture medium containing 2% glucose was used as the selective culture medium. When the colonies had grown to a suitable size on the agar plate culture, a Sudan Black B solution was sprayed thereon, and the colonies which emit fluorescence by UV light projection were collected. From the collected colonies, a plasmid was recovered by an alkali method to obtain a DNA fragment containing the gene of the PHB-synthesizing enzyme group.

The obtained gene fragment was recombined with a vector pBBR122 (Mo Bi Tec) which contains broad host range replication region and does not belong to incompatible groups of IncP, IncQ, and IncW. The recombinant plasmid was transformed to by electroporation to the TB64ml strain (PHB synthesis ability-deficient strain) of Ralstonia eutropha. Thereby the PHB synthesis ability of the TB64 ml was restored and became complementary.

The base sequence of the fragment containing the gene of a PHB-synthesizing enzyme group was determined by a Sanger's method. Thereby, the gene of the PHB-synthesizing enzyme group having the base sequence shown by Sequence No. 1 was confirmed to exist in the fragment.

Next, an oligonucleotide which has a base sequence around the initiation codon of the PHB-synthesizing enzyme gene, shown by Sequence No. 2, was designed and synthesized (Amersham Pharmacia Biotech Co.). PCR was conducted by using this oligonucleotide as the primer to amplify the fragment containing the PHB-synthesizing enzyme gene (LA-PCR kit; Takara Shuzo Co.).

The PCR-amplified fragment obtained above was subjected to complete breakdown by use of a restriction enzyme BamHI. The resulting product was connected to manifestation vector pUC18 that has been leaved by the restrictin enzyme BamHI and subjected to dephosphorylation treatment (Molecular Cloning, Vol.1, page 572, 1989, published by Cold Spring Harbor Laboratory) by means of a DNA Ligation Kit Ver. II (Takara Shuzo Co.).

With the obtained recombinant plasmid, Eschericia coli HB101 was transformed by a calcium chloride method (Takara Shuzo Co.). A recombinant plasmid pTB64-phb was recovered from the resulting recombinant plasmid.

Escherichia coli was transformed by the obtained recombinant plasmid by a calcium chloride method (Takara Shuzo Co.) to obtain a pTB64-phb recombinant strain.

<Preparation of Transformant Having GST-Fused PHB-Synthesizing Enzyme Productivity>

The pTB64-phb recombinant strain was inoculated to 200 mL of an LB culture medium, and was cultivated at 37° C. by shaking at 125 strokes per minute. After cultivation for 12 hours, 200 mL of the liquid culture was added to 200 mL of an LB culture medium containing 2% of glucose (400 mL in total), and cultivation was continued at 37° C. for 12 hours by shaking at 125 strokes per minute. The resulting bacterium mass was recovered by centrifugation, and therefrom a plasmid DNA was recovered.

An oligonucleotide (Sequence No. 3) as a primer upstream to the pTB64-phb, and an oligonucleotide (Sequence No. 4) as a primer downstream thereto were respectively designed and synthesized (Amersham Pharmacia Biotech Co.). PCR was conducted with the oligonucleotides as the primers and the pTB64-phb as the template to amplify the entire length of the PHB-synthesizing enzyme gene having a BamHI restriction site in the upstream and an XhoI restriction site in the downstream (LA-PCR kit, Takara Shuzo Co.).

The purified PCR-amplified product was digested by BamHI and XhoI, and was inserted into the corresponding site of a plasmid pGEX-6P-1 (produced by Amersham Pharmacia Biotech Co.). By use of these vectors, Escherichia coli (JM109) was transformed into a manifestation strain. The kind of the obtained strain was confirmed by producing the plasmid DNA in a large amount by means of Miniprep (Wizard Minipreps DNA Purification Systems, manufactured by Promega Co.), treating the plasmid DNA with BamHI and XhoI, and identifying the obtained DNA fragment.

<Preparation of PHB-Synthesizing Enzyme>

The obtained manifestation strain was cultivated at 30° C. overnight in 100 mL of a 2×YT culture medium (polypeptone 16 g/L, yeast extract 10 g/L, NaCl 5 g/L, pH 7.0) containing ampicillin (100 μg/L).

This culture was added to 10 liters of 2×YT culture medium (polypeptone 16 g/L, yeast extract 10 g/L, NaCl 5 g/L, pH 7.0) containing ampicillin (100 μg/L. The mixture was cultivated at 30° C. for 3 hours. Thereto isopropyl-β-D-thiogalactopyranoside (IPTG) was added to the final concentration of 1 mM, and the cultivation was continued at 30° C. for 3 hours.

The liquid culture was centrifuged at 4° C. at 8000 g for 10 minutes. After removing the supernatant, the bacterium mass pellet was suspended again in 500 mL of a PBS solution at 4° C. This bacterium liquid suspension was put by 40 mL portion in a vessel preliminarily cooled to 4° C. to crush the bacterium mass by a French press at a pressure of 2200 kg/cm² by gradually releasing the bacterium liquid through the nozzle. The crushed bacterium liquid was centrifuged at 4° C. at 8000 g for 10 minutes, and the supernatant was recovered. The recovered supernatant was filtered through a 0.45 μm filter to remove a solid contaminant. The supernatant was found to contain the intended PHB-synthesizing enzyme having glutathione-S-transferase(GST) fused thereto by SDS-PAGE.

The GST-fused PHB-synthesizing enzyme was purified by use of Glutathion Sepharose 4B (produced by Amersham Pharmacia Biotech Co.). A 6.65 mL of 75% slurry of the Glutathion Sepharose 4B was centrifuged at 4° C. at 500 g for 5 minutes to remove the supernatant. The recovered solid was suspended again in 200 mL of a PBS solution at 4° C. The suspension was centrifuged at 4° C. at 500 g for 5 minutes to remove the supernatant. The obtained solid was suspended again in 5 mL of a PBS solution at 4° C. to prepare 50% slurry of Glutathion Sepharose 4B.

To 10 mL of 50% slurry of this Glutathion Sepharose 4B, the entire amount of the above prepared supernatant was added, and the intended fused protein in the supernatant was allowed to adsorb onto the Glutathion Sepharose 4B by affinity adsorption by gentle shaking. The mixture was centrifuged at 4° C. at 500 g for 5 minutes. After removing the supernatant, the solid matter was suspended again in 5 mL of a PBS solution at 4° C. The suspension was centrifuged similarly, and the supernatant was removed. The resulting Glutathion Sepharose 4B having the GST-fused PHB-synthsizing enzyme immobilized thereon was used as Immobilized Enzyme (1).

Later, re-suspension and centrifugation were repeated twice followed by washing, and finally the solid matter was suspended in 5 mL of a Cleavage buffer solution (Tris-HCl 50 mM, NaCl 150 mM. EDTA 1 mM, dithiothreitol 1 mM, pH 7). Thereto, was added 0.5 mL of a 4% solution of PreScission Protease (produced by Amersham Pharmacia Biotech Co.) in a Cleavage buffer solution, and the mixture was shaken gently at 5° C. for 4 hours. The mixture was centrifuged at 4° C. at 500 g for 5 minutes to recover the supernatant. Separately a 1 mL portion of a 50% slurry of Glutathion Sepharose 4B prepared in the same manner as before was centrifuged at 4° C. at 500 g for 5 minutes to remove the supernatant. To the separated Glutathion Sepharose 4B, the supernatant recovered above was added and the mixture was stirred gently to allow the PreScission Protease remaining in the supernatant to adsorb onto the Glutathion Sepharose 4B. Then the supernatant was recovered by centrifugation at 4° C. at 500 g for 5 minutes. This supernatant exhibited a single band in SDS-PAGE analysis, showing the purified state.

The enzymatic activity of the contained PHB-synthesizing enzyme was measured according to the method shown below. Firstly, 100 μl of a 3.0 mg/mL solution of bovine serum albumin (Sigma Co.) in 0.1 M tris-HCl buffer solution (pH 8.0) was added to 100 μl of the enzyme solution, and mixed. The mixture was pre-incubated at 30° C. for one minute. Thereto was added 100 μl of a 3.0 mM solution of 3-hydroxybutyryl CoA in 0.1 M tris-HCl buffer solution (pH 8.0). The mixture was incubated at 300C for 1-30 minutes. The reaction was terminated by addition of 300 μl of a 10 mg/mL trichloroacetic acid solution in a 0.1 M tris-HCl buffer solution (pH 8.0). The solution after the termination of the reaction was centrifuged (15000×g for 10 minutes). To 500 μl of the supernatant solution, was added 500 μl of 2.0 mM 5,5′-dithiobis(2-nitrobenzoic acid) solution in a 0.1 M tris-HCl buffer solution (pH 8.0). The mixture was incubated at 30° C. for 10 minutes. Then the optical absorbance of the solution was measured at 412 nm. The enzymatic activity was calculated by taking the amount of the enzyme to release 1 μmol of CoA per minute as one unit (U) of the enzyme. As the result, the relative activity was found to be 7.5 U/mL. This solution was concentrated by ultrafiltration by addition of a Raiho gel to a concentration of 10 U/mL. This solution was named “Purified Enzyme Solution (1)”.

<Method of Preparation of Crude Enzyme Solution Containing PHB-Synthesizing Enzyme>

The KK01 strain and TL2 strain were respectively cultivated at 30° C. for 24 hours in 10 L of an M9 culture medium (composition shown below) containing 0.5% of a yeast extract and 0.3% of a mineral solution (shown below). The liquid culture was centrifuged at 4° C. at 8000 g for 10 minutes. After removing the supernatant, the bacterium mass pellet was suspended again in 500 mL of a PBS solution at 4° C. This bacterium liquid suspension was put by 40 mL portion in a vessel preliminarily cooled to 4° C. by a French Press at a pressure of 2200 kg/cm to gradually release the bacterium liquid through the nozzle to crush the bacterium mass. The crushed bacterium liquid was centrifuged at 4° C. at 8000 g for 10 minutes, and the supernatant was recovered. The recovered supernatant was filtered through a 0.45 μm filter to remove solid contaminant. The activity of the PHA-synthesizing enzyme contained was measured by the measurement method described above. As the results, the KK01 strain gave a relative activity of 1.6 U/mL, and the TL2 strain gave a relative activity of 1.2 U/mL. The solutions were respectively concentrated by ultrafiltration by addition of a Raiho gel to a concentration of 10 U/mL. The crude enzyme solution derived from the KK01 strain was named “Crude Enzyme Solution (1)”, and the one derived from TL2 strain was named “Crude Enzyme Solution (2)”.

(M9 Culture Medium)

| | |
|---|---|
| Na₂HPO₄ | 6.2 g |
| KH₂PO₄ | 3.0 g |
| NaCl | 0.5 g |
| NH₄Cl | 1.0 g |

(per liter of culture medium, pH 7.0)

(Mineral Solution)

| | |
|---|---|
| Nitrilotriacetic acid | 1.5 g |
| MgSO₄ | 3.0 g |
| MnSO₄ | 0.5 g |
| NaCl | 1.0 g |
| FeSO₄ | 0.1 g |
| CaCl₂ | 0.1 g |
| CoCl₂ | 0.1 g |
| ZnSO₄ | 0.1 g |
| CuSO₄ | 0.1 g |
| AlK(SO₄)₂ | 0.1 g |
| H₃BO₃ | 0.1 g |
| Na₂MoO₄ | 0.1 g |
| NiCl₂ | 0.1 g |

(per liter, pH 7.0)

### Example 1

A capsular structure of the present invention which has Glutathion Sepharose 4B having GST-fused PHB-synthesizing enzyme as the core was prepared in the method described below.

1 part by mass of Immobilized Enzyme (1) was suspended in 48 parts by mass of 0.1 M phosphate buffer solution (pH 7.0) Thereto, were added 1 part by mass of 3-hydroxybutyryl CoA (produced by Sigma Aldrich Japan Co.) and 0.1 part by mass of bovine serum albumin (produced by Sigma Co.). The mixture was shaken gently at 30° C. for 2 hours.

10 μl of the above reaction mixture was placed on a slide glass. Thereto, 10 μl of an aqueous 1% Nile Blue A solution was added and mixed on the slide glass. A cover glass was placed thereon. The mixture was observed with a fluorescence microscope (excitation filter for 330-380 nm, long pass absorption filter for 420 nm, manufactured by Nikon Corp.). The surface of the Glutathion Sepharose 4B was observed to be emitting fluorescence. Thereby, the surface of the Glutathion Sepharose 4B was found to be coated with PHB.

As the control, 10 parts by mass of Glutathion Sepharose 4B was added to 90 parts by mass of a 0.1M phosphate buffer solution (pH 7.0), and the mixture was shaken gently at 30° C. for 2.5 hours. After staining with Nile Blue A in the same manner as above, the Glutathion Sepharose 4B was examined with a fluorescence microscope. Thereby the surface of the Glutathion Sepharose 4B was found not to emit fluorescence.

A portion of the above PHB-coated particles was recovered by centrifugation (10,000×g, 4° C., 10 minutes) and vacuum-dried. The particles were suspended and stirred in chloroform at 60° C. for 20 hours to extract the PHB constituting the outer shell. The liquid extract was filtered through a membrane filter having a pore diameter of 0.45 μm, and was concentrated at a reduced pressure by means of a rotary evaporator. The concentrated matter was treated for methanolysis in a conventional manner, and was subjected to Gas Chromatography/Mass Spectrometry analysis (GC/MS, Shimadzu QP-5050, EI method) to identify the methyl ester of the monomer unit. As the result, the extract was found to be PHB constituted of 3-hydroxybutyric acid units.

The molecular weight of the PHB was measured by Gel Permeation Chromatography (GPC: Tosoh HLC-8020, column: Polymer Laboratory PLgel MIXED-C (5 μm), Solvent: chloroform, column temperature: 40° C., in terms of polystyrene). As the results, it was found that Mn=34,000, and Mw=54,000.

### Example 2

A capsular structure of the present invention having alumina as the core material was prepared by use of a purified PHB-synthesizing enzyme solution according to the method below.

To 10 parts by mass of Purified Enzyme Solution (1), were added 1 part by mass of alumina particles (particle diameter: 0.12-135 μm) and 39 parts by mass of PBS. The mixture was shaken gently at 30° C. for 30 minutes to allow the PHB-synthesizing enzyme to adsorb on the alumina surface. The alumina particles were collected by centrifugation (10,000×g, 4° C., 10 minutes). The precipitate was suspended in a PBS solution, and again centrifuged (10,000×g, 4° C., 10 minutes) to obtain an immobilized enzyme.

The above immobilized enzyme was suspended in 48 parts by mass of a 0.1M phosphate buffer solution (pH 7.0). Thereto, were added 1 part by mass of 3-hydroxybutyryl CoA (produced by Sigma Aldrich Japan Co.), and 0.1 part by mass of bovine serum albumin (produced by Sigma Co.). The mixture was shaken gently at 30° C. for 2 hours.

10 μl of the above reaction mixture was placed on a slide glass. Thereto, 10 μl of an aqueous 1% Nile Blue A solution was added and mixed on the slide glass. A cover glass was placed thereon. The mixture was observed with a fluorescence microscope (excitation filter for 330-380 nm, long pass absorption filter for 420 nm, manufactured by Nikon Corp.). The surface of the alumina particles was observed emitting fluorescence. Thereby, the surface of the alumina particles was found to be coated with PHB.

As the control, 1 part by mass of the alumina particles was added to 49 parts by mass of a 0.1M phosphate buffer solution (pH 7.0), and the mixture was shaken gently at 30° C. for 2.5 hours. After staining with Nile Blue A in the same manner as above, the alumina particles were examined with a fluorescence microscope. Thereby the surface of the alumina particles was found not to emit fluorescence at all.

A portion of the above PHB-coated particles was recovered by centrifugation (10,000×g, 4° C., 10 minutes) and vacuum-dried. The particles were suspended and stirred in chloroform at 60° C. for 20 hours to extract the PHB constituting the outer shell. The liquid extract was filtered through a membrane filter having a pore diameter of 0.45 μm, and was concentrated at a reduced pressure by means of a rotary evaporator. The concentrated matter was treated for methanolysis in a conventional manner, and was subjected to Gas Chromatography/Mass Spectrometry analysis (GC/MS, Shimadzu QP-5050, EI method) to identify the methyl ester of the monomer unit. As the result, the extract was found to be PHB constituted of 3-hydroxybutyric acid units.

The molecular weight of the PHB was measured by Gel Permeation Chromatography (GPC: Tosoh HLC-8020, column: Polymer Laboratory PLgel MIXED-C (5 μm), Solvent: chloroform, column temperature: 40° C., in terms of polystyrene). As the results, it was found that Mn=31,000, and Mw=50,000.

### Example 3

A capsular structure of the present invention having alumina as the core material was prepared by use of a crude enzyme solution containing a PHB-synthesizing enzyme solution.

To 10 parts by mass of Crude Enzyme Solution (1), were added 1 part by mass of alumina particles (particle diameter: 0.12-135 μm) and 39 parts by mass of PBS. The mixture was shaken gently at 30° C. for 30 minutes to allow the PHB-synthesizing enzyme to adsorb on the alumina surface. The alumina particles were collected by centrifugation (10,000×g, 4° C., 10 minutes). The precipitate was suspended again in a PBS solution, and again centrifuged (10,000×g, 4° C., 10 minutes) to obtain an immobilized enzyme.

The above immobilized enzyme was suspended in 48 parts by mass of a 0.1M phosphate buffer solution (pH 7.0). Thereto, were added 1 part by mass of 3-hydroxybutyryl CoA (produced by Sigma Aldrich Japan Co.), and 0.1 part by mass of bovine serum albumin (produced by Sigma Co.). The mixture was shaken gently at 30° C. for 2 hours.

10 μl of the above reaction mixture was placed on a slide glass. Thereto, 10 μl of an aqueous 1% Nile Blue A solution was added and mixed on the slide glass. A cover glass was placed thereon. The mixture was observed with a fluorescence microscope (excitation filter for 330-380 nm, long pass absorption filter for 420 nm, manufactured by Nikon Corp.). The surface of the alumina particles was observed emitting fluorescence. Thereby, the surface of the alumina particles was found to be coated with PHB.

As the control, 1 part by mass of the alumina particles was added to 49 parts by mass of a 0.1M phosphate buffer solution (pH 7.0), and the mixture was shaken gently at 30° C. for 2.5 hours. After staining with Nile Blue A in the same manner as above, the alumina particles were examined with a fluorescence microscope. Thereby the surface of the alumina particles was found not to emit fluorescence at all.

A portion of the above PHB-coated particles was recovered by centrifugation (10,000×g, 4° C., 10 minutes) and vacuum-dried. The particles were suspended and stirred in chloroform at 60° C. for 20 hours to extract the PHB constituting the outer shell. The liquid extract was filtered through a membrane filter having a pore diameter of 0.45 μm, and was concentrated at a reduced pressure by means of a rotary evaporator. The concentrated matter was treated for methanolysis in a conventional manner, and was subjected to Gas Chromatography/Mass Spectrometry analysis (GC-MS, Shimadzu QP-5050, EI method) to identify the methyl ester of the monomer unit. As the result, the extract was found to be PHB constituted of 3-hydroxybutyric acid units.

The molecular weight of the PHB was measured by Gel Permeation Chromatography (GPC: Tosoh HLC-8020, column: Polymer Laboratory PLgel MIXED-C (5 μm), Solvent: chloroform, column temperature: 40° C., in terms of polystyrene). As the results, it was found that Mn=28,000, and Mw=45,000.

### Example 4

A capsular structure of the present invention having alumina as the core material was prepared by use of a crude enzyme solution containing a PHB-synthesizing enzyme solution.

To 10 parts by mass of Crude Enzyme Solution (2), were added 1 part by mass of alumina particles (particle diameter: 0.12-135 μm) and 39 parts by mass of PBS. The mixture was shaken gently at 30° C. for 30 minutes to allow the PHB-synthesizing enzyme to adsorb onto the alumina surface. The alumina particles were collected by centrifugation (10,000×g, 4° C., 10 minutes). The precipitate was suspended in a PBS solution, and again centrifuged (10,000×g, 4° C., 10 minutes) to obtain an immobilized enzyme.

The above immobilized enzyme was suspended in 48 parts by mass of a 0.1M phosphate buffer solution (pH 7.0). Thereto, were added 1 part by mass of 3-hydroxybutyryl CoA (produced by Sigma Aldrich Japan Co.), and 0.1 part by mass of bovine serum albumin (produced by Sigma Co.). The mixture was shaken gently at 30° C. for 2 hours.

10 μl of the above reaction mixture was placed on a slide glass. Thereto, 10 μl of an aqueous 1% Nile Blue A solution was added and mixed on the slide glass. A cover glass was placed thereon. The mixture was observed with a fluorescence microscope (excitation filter for 330-380 nm, long pass absorption filter for 420 nm, manufactured by Nikon Corp.). The surface of the alumina particles was observed emitting fluorescence. Thereby, the surface of the alumina particles was found to be coated with PHB.

As the control, 1 part by mass of the alumina particles was added to 49 parts by mass of a 0.1M phosphate buffer solution (pH 7.0), and the mixture was shaken gently at 30° C. for 2.5 hours. After staining with Nile Blue A in the same manner as above, the alumina particles were examined with a fluorescence microscope. Thereby the surface of the alumina particles was found not to emit fluorescence at all.

A portion of the above PHB-coated particles was recovered by centrifugation (10,000×g, 4° C., 10 minutes) and vacuum-dried. The particles were suspended and stirred in chloroform at 60° C. for 20 hours to extract the PHB constituting the outer shell. The liquid extract was filtered through a membrane filter having a pore diameter of 0.45 μm, and was concentrated at a reduced pressure by means of a rotary evaporator. The concentrated matter was treated for methanolysis in a conventional manner, and was subjected to Gas Chromatography/Mass Spectrometry analysis (GC/MS, Shimadzu QP-5050, EI method) to identify the methyl ester of the monomer unit. As the result, the extract was found to be PHB constituted of 3-hydroxybutyric acid units.

The molecular weight of the PHB was measured by Gel Permeation Chromatography (GPC: Tosoh HLC-8020, column: Polymer Laboratory PLgel MIXED-C (5 μm), Solvent: chloroform, column temperature: 40° C., in terms of polystyrene). As the results, it was found that Mn=29,000, and Mw=46,000.

### Example 5

The mixture having the composition below was placed in a 3-liter four-neck separable flask equipped with a reflux condenser, a thermometer, a nitrogen-introducing tube, and a stirrer. The mixture was stirred by a high-speed stirrer, TK-Homomixer, at a speed of 10,000 rpm for 10 minutes to form particles. Then the stirring speed was reduced to 1,000 rpm, and nitrogen gas was bubbled into the flask sufficiently. Thereafter the stirrer blade was changed to a crescent-shaped blade, and polymerization was allowed to proceed with gentle stirring in an oil bath kept at 80° C. for 16 hours.

| | |
|---|---|
| Deionized water | 1200 parts |
| Polyvinyl alcohol | 15 parts |
| Sodium dodecylsulfate | 0.1 parts |
| Styrene monomer | 75 parts |
| N-Butyl acrylate | 25 parts |
| Di-t-butylsalicylic acid chromium complex | 5 parts |
| Copper phthalocyanine | 5 parts |
| 2,2-Azobis (2,4-dimethylvaleronitrile) | 6 parts |

After completion of the polymerization reaction, the reaction flask was cooled to room temperature, and the dispersion was washed five times by decantation, filtered, washed, and dried to obtain Core Particles (1) in a blue powder state. The core particles had a weight-average particle diameter of 6.5 μm by measurement with a Coulter Counter Multisizer (manufactured by Coulter Co.).

Core Particles (1) had a glass transition temperature (Tg) of 88.5° C. by measurement with a differential scanning calorimeter (DSC-7, manufactured by Perkin Elmer Co.).

Core Particles (1) were encapsulated in a manner as described below.

To 10 parts by mass of Purified Enzyme Solution (1), were added one part by mass of Core Particles (1) and 39 parts by mass of PBS. The mixture was shaken gently at 30° C. for 30 minutes to allow the PHB-synthesizing enzyme to adsorb onto the core particle surface. The core particles were collected by centrifugation (10,000×g, 4° C., 10 minutes). The precipitate was suspended in a PBS solution, and again centrifuged (10,000×g, 4° C., 10 minutes) to obtain an immobilized enzyme.

The above immobilized enzyme was suspended in 48 parts by mass of a 0.1M phosphate buffer solution (pH 7.0). Thereto, were added 1 part by mass of 3-hydroxybutyryl CoA (produced by Sigma Aldrich Japan Co.), and 0.1 part by mass of bovine serum albumin (produced by Sigma Co.). The mixture was shaken gently at 30° C. for 2 hours.

After the reaction, the obtained particles were collected by filtration, washed with water, and dried under a reduced pressure at 40° C. for 4 hours to obtain blue Capsular Toner (1). This Capsular Toner (1) had a weight-average particle diameter of 7.1 μm by measurement in the same manner as described above.

This Capsular Toner (1) had a glass transition temperature (Tg) of 70.8° C. by measurement in the same manner as described above.

This Capsular Toner (1) had particles having a smooth surface and a blue core therein according to optical microscope observation.

For microscopic examination, Capsular Toner (1) was fixed on an aluminum sample stand with an electroconductive tape, and thereon gold was vapor-deposited in a thin layer by an ion coater. The shape of the fine polymer particles was observed by a scanning electron microscope. The observation showed that Core Particles (1) were completely coated by a capsule shell having a smooth surface.

For microscopic examination, Capsular Toner (1) was hardened with an epoxy resin, and was cut into an ultrathin piece by a microtome. The thin piece was stained with osmium tetraoxide, and was observed at a magnification ratio of 10,000 to 100,000 by a transmission electron microscope. The observation showed that the capsular structure had two layer structure constituted of a core and a shell. From the difference in the stain densities, the thickness of the shell was estimated to be 0.34 μm in average.

From this measurement result, the volume ratio of the blue core particles (1) to Capsular Toner (1) was found to be 77% (V/V), showing the presence of the core particles as the coloring material component in a high density in the capsular structure.

A Toner Composition (1) was prepared by mixing 10 parts by mass of Capsular Toner (1) and 0.2 part of hydrophobic silica having been disintegrated and having a BET value of 360 m²/g using a Henschel mixer.

For evaluation of the toner image formed with the prepared toner, Two-Component Developer (1) was prepared by mixing 6 parts of the above toner, and 94 parts of a carrier (prepared from ferrite cores of an average particle diameter of 35 Am coated with a silicone resin) in a polyethylene bottle by means of a tumbling mixer. With this developer, images were formed by a modified type of full-color laser copier copying machine CLC-500 manufactured by Canon K.K. under the environmental conditions of 23° C. and 60% RH. The formed images in the initial stage and after 10,000 sheets of copying were observed by SEM for evaluation of the image quality and deterioration of the developer.

The picture image quality was evaluated by reproducibility of the minimum spots in multivalued recording by pulse width modulation (PWM) in one picture element by microscopic observation. The formed images were excellent in half-tone dot reproducibility in the initial stage as well as after 10,000 sheets of copying without soiling the developing unit and the photosensitive member. Neither breaking nor crushing of the toner was observed at all, and toner-spent onto the carrier surface was not observed.

For evaluation of blocking resistance of the toner, Toner Composition (1) obtained above was left standing at the temperatures set at intervals of 1° C. from 50 to 70° C. for 3 days. Thereafter the blocking was observed, and images were formed with the toner compositions for image evaluation. The temperature at which the image roughness comes to change in the highlight region was taken as the blocking resistance temperature. Toner Composition (1) had a blocking resistance temperature of as high as 62° C., showing excellent blocking resistance.

The fixability of the toner was evaluated by a separate fixability test unit having the same constitution as that of the fixing unit of CLC-500. In the fixability test, a toner image was formed in an unfixed state on rectangular paper sheet strips having a width of 2 cm and a length of 10 cm, the unfixed image was fixed by passing the paper sheet strip lengthwise through the rollers of the fixability test unit with monitoring of the temperature of the upper roller thereof. The fixability was evaluated in terms of occurrence of offset at the rear end of the paper sheet strip. As the result, the fixation initiation temperature was as low as 97° C., showing excellent low-temperature fixability.

### Comparative Example 1

Core Particles (1) in an uncapsuled state were used in place of Capsular Toner (1) as the toner composition, and as a two-component developer, and were evaluated in the same manner as in Example 5. As the results, although the blocking resistance temperature was sufficiently as high as 74° C., the fixation initiation temperature was 115° C., disadvantageously high.

### Example 6

The mixture of the materials shown below were melt-blended by means of a kneader controlled to be at a temperature of 150-180° C. for 10 minutes, and cooled and solidified. This solidified mixture was crushed roughly by a coarse crusher, then finely pulverized by a jet mill, and classified by an air-stream classifier to obtain Core Particles (2) as a black powdery matter.

| | |
|---|---|
| Polyester resin | 100 parts |
| Carbon black | 6 parts |
| Di-t-butylsalcylic acid chromium complex | 5 parts |

Core Particles (2) had a weight-average particle diameter of 4.3 μm by measurement with a Coulter Counter Multisizer (manufactured by Coulter Co.), and a glass transition temperature (Tg) of 42.6° C. by measusrement with a differential scanning calorimeter (DSC-7, manufactured by Perkin Elmer Co.).

Core Particles (2) were capsuled as described below. To 10 parts by mass of Crude Enzyme Solution (1), were added one part by mass of Core Particles (2) and 39 parts by mass of PBS. The mixture was shaken gently at 30° C. for 30 minutes to allow the PHB-synthesizing enzyme to adsorb onto the core particle surface. The core particles were centrifuged (10,000×g, 4C, 10 minutes). The precipitate was suspended in a PBS solution and centrifuged again (10,000×g, 4° C., 10 minutes) to obtain an immobilized enzyme.

The obtained immobilized enzyme was suspended in 48 parts by mass of a 0.1M phosphate buffer (pH 7.0). Thereto, were added one part by mass of 3-hydroxybutyryl CoA (Sigma Aldrich Japan Co.) and 0.1 part by mass of bovine serum albumin. The mixture was shaken gently at 30° C. for 2 hours. After the reaction, the particles were collected by filtration, washed with water, and dried at 40° C. for 4 hours under a reduced pressure to obtain a black Capsule Toner (2). This Capsule Toner (2) had a weight-average particle diameter of 4.8 μm by measurement in the same manner as above.

This Capsular Toner (2) had a glass transition temperature (Tg) of 70.2° C. by measurement in the same manner as described above.

The particle of this Capsular Toner (2) had a smooth surface and a black core therein according to optical microscope observation.

Core Particle (2) were confirmed to be completely coated by a capsule shell having a smooth surface by observation with a scanning electron microscope in the same manner as in Example 5.

The capsule was confirmed to have a two-layer structure constituted of a core and a shell by transmission electron microscopy. From the difference in the stain densities, the thickness of the shell was estimated to be 0.26 μm in average.

From this measurement result, the volume ratio of the black Core Particles (2) to Capsular Toner (2) was found to be 73% (V/V), showing the presence of the core particles as the coloring material component in a high density in the capsular structure.

Toner Composition (2) was prepared by addition of hydrophobic silica, and therefrom Two-Component Developer (2) was prepared in the same manner as in Example 5. The quality of the image formed with this Developer (2), and deterioration of Developer (2) were evaluated in the same manner as in Example 5. The formed images were excellent in half-tone dot reproducibility in the initial stage as well as after 10,000 sheets of copying without soiling the developing unit and the photosensitive member. Neither breaking nor crushing of the toner was observed at all, and toner-spent onto the carrier surface was not observed.

The blocking resistance of the toner was evaluated in the same manner as in Example 5. Toner Composition (2) had a blocking resistance temperature of as high as 60C, showing excellent blocking resistance.

The fixability of the toner was evaluated in the same manner as in Example 5. The fixation initiation temperature was as low as 94° C., showing excellent low-temperature fixability.

### Comparative Example 2

Core Particles (2) in an uncapsuled state were used in place of Capsular Toner (2) as a toner composition, and as a two-component developer, and were evaluated in the same manner as in Example 5. As the results, although the fixation initiation temperature was as low as 92C, showing excellent low-temperature fixability, the blocking resistance temperature was as low as 51° C., causing poor blocking resistance.

### Example 7

The mixture of the materials shown below were melt-blended by means of a kneader controlled to be at a temperature of 150-180° C. for 10 minutes, and cooled and solidified. This solidified mixture was crushed roughly by a coarse crusher, then finely pulverized by a jet mill, and classified by an air-stream classifier to obtain Core Particles (3) as a yellow powdery matter.

| | |
|---|---|
| Epoxy resin | 100 parts |
| C.I. Pigment Yellow 12 | 6 parts |
| Di-t-butylsalcylic acid chromium complex | 5 parts |

The obtained Core Particles (3) had a weight-average particle diameter of 7.5 μm by measurement with a Coulter Counter Multisizer (manufactured by Coulter Co.), and a glass transition temperature (Tg) of 88.5° C. by measurement with a differential scanning calorimeter (DSC-7, manufactured by Perkin Elmer Co.).

Core Particles (3) were capsuled as described below. To 10 parts by mass of Crude Enzyme Solution (2), were added one part by mass of Core Particles (3) and 39 parts by mass of PBS. The mixture was shaken gently at 30° C. for 30 minutes to allow the PHB-synthesizing enzyme to adsorb onto the core particle surface. The core particles were centrifuged (10,000×g, 4° C., 10 minutes). The precipitate was suspended in a PBS solution and centrifuged again (10,000×g, 4° C., 10 minutes) to obtain an immobilized enzyme.

The obtained immobilized enzyme was suspended in 48 parts by mass of a 0.1M phosphate buffer (pH 7.0). Thereto, were added one part by mass of 3-hydroxybutyryl CoA (produced by Sigma Aldrich Japan Co.) and 0.1 part by mass of bovine serum albumin (produced by Sigma Co.). The mixture was shaken gently at 30° C. for 2 hours. After the reaction, the particles were collected by filtration, washed with water, and dried at 40° C. for 4 hours under a reduced pressure to obtain a yellow Capsular Toner (3). This Capsular Toner (3) had a weight-average particle diameter of 8.4 μm by measurement in the same manner as above. This Capsular Toner (3) had a glass transition temperature (Tg) of 70.8° C. by measurement in the same manner as described above.

The particles of this Capsular Toner (3) had a smooth surface and a yellow core therein according to optical microscope observation.

Core Particle (3) were confirmed to be completely covered by a capsule shell having a smooth surface by observation with a scanning electron microscope in the same manner as in Example 5.

The capsule was confirmed to have a two layer structure constituted of a core and a shell by transmission electron microscopy. From the difference in the stain densities, the thickness of the shell was estimated to be 0.47 μm in average.

From this measurement result, the volume ratio of the yellow Core Particles (3) to Capsular Toner (3) was found to be 71% (V/V), showing the presence of the core particles as the coloring material component in a high density in the capsular structure.

Toner Composition (3) was prepared by addition of hydrophobic silica, and therefrom two-component Developer (3) was prepared in the same manner as in Example 5. The quality of the image formed with this Developer (3), and deterioration of Developer (3) were evaluated in the same manner as in Example 5. The formed images were excellent in half-tone dot reproducibility in the initial stage as well as after 10,000 sheets of copying without soiling the developing unit and the photosensitive member. Neither breaking nor crushing of the toner was observed at all, and toner-spent onto the carrier surface was not observed.

The blocking resistance of the toner was evaluated in the same manner as in Example 5. Toner Composition (3) had a blocking resistance temperature of as high as 62° C., showing excellent blocking resistance.

The fixability of the toner was evaluated in the same manner as in Example 5. The fixation initiation temperature was as low as 98° C., showing excellent low-temperature fixability.

### Comparative Example 3

Core Particles (3) in an uncapsuled state were used in place of Capsular Toner (3) as a toner composition, and as a two-component developer, and were evaluated in the same manner as in Example 5. As the results, although the blocking resistance temperature was sufficiently as high as 77° C., the fixation initiation temperature was 119° C., disadvantageously high.

The present invention has been described in detail by reference to preferred embodiments. It will now be obvious that any changes and modifications may be made without departing from the invention in its broader aspects, and it is the intention, therefore, in the appended claims to cover all such changes and modifications within the true spirit of the invention.

What is claimed is:

1. A granular structure, comprising granules coated at least partly with a polyhydroxyalkanoate constituted of at least one monomer unit selected from the group consisting of 3-hydroxypropionic acid, 3-hydorxy-n-butyric acid, and 3-hydroxy-n-valeric acid.

2. The granular structure according to claim 1, wherein the granules contain at least a coloring material.

3. The granular structure according to claim 2, wherein the coloring material contains at least a pigment.

4. The granular structure according to claim 1, wherein the granules are pigment granules

5. A process for producing a granular structure having granules coated at least partly with a polyhydroxyalkanoate constituted of at least one monomer unit selected from the group consisting of 3-hydroxypropionic acid, 3-hydorxy-n-butyric acid, and 3-hydroxy-n-valeric acid: the process comprising the steps of dispersing granules in an aqueous medium;
immobilizing a polyhydroxyalkanoate-synthesizing enzyme on the surface of the granules dispersed in the aqueous medium; and
synthesizing the polyhydroxyalkanoate by polymerizing at least one coenzyme selected from the group consisting of 3-hydorxypropionyl coenzyme A, 3-hydroxybutyryl coenzyme A, and 3-hydroxyvaleryl coenzyme A to coat at least a part of the granules with the polyhydroxyalkanoate.

6. The process for producing the granular structure according to claim 5, wherein the granules contain at least a coloring material.

7. The process for producing the granular structure according to claim 6, wherein the coloring material contains at least a pigment.

8. The process for producing the granular structure according to claim 5, wherein the granules are pigment granules.

9. The process for producing the granular structure according to claim 5, wherein the polyhydroxyalkanoate-synthesizing enzyme is produced by a microorganism having production capability for producing the polyhydroxyalkanoate-synthesizing enzyme or produced by a transformant into which a gene that contributes to the production capability has been introduced.

10. The process for producing the granular structure according to claim 9, wherein the microorganism having the production capability for producing the polyhydroxyalkanoate-synthesizing enzyme is at least one microorganism selected from the group consisting of Burkholderia cepacia KK01 (FERM BP-4235), Ralstonia eutropha TB64 (FERM BP-6933), and Alcaligenes sp. TL2 (FERM BP-6913).

11. An electrophotographic toner, which comprises the granular structure according to claim 1.

12. An electrophotographic toner, which is composed of the granular structure according to claim 1.

13. A process for producing an electrophotographic toner, comprising at least the step of producing a granular structure by employing the process according to claim 5.
